(19) United States
(12) Patent Application Publication
(10) Pub. No.: US 2020/0132813 A1
(43) Pub. Date: Apr. 30, 2020

(54) VEHICLE FRONT STRUCTURE

(71) Applicant: TOYOTA JIDOSHA KABUSHIKI KAISHA, Aichi-ken (JP)

(72) Inventor: Shunsuke YAMAMOTO, Toyota-shi (JP)

(21) Appl. No.: 16/655,232

(22) Filed: Oct. 17, 2019

(30) Foreign Application Priority Data
Oct. 26, 2018 (JP) 2018-201660

(51) Int. Cl. G01S 7/481; B60K 11/04; B60R 13/04; G01S 17/93

(52) U.S. Cl. CPC G01S 7/4813; G01S 17/936; B60R 13/04; B60K 11/04

(57) ABSTRACT

A space is formed behind a radiator grille to ensure passage of air from an air hole into a vehicle. The radiator grille includes a planar mounting portion having an opening. A lidar assembly includes a lidar and an attachment. The attachment is fastened to the mounting portion using screws and bolts, thereby mounting the lidar assembly to the mounting portion. The lidar, in its mounted state, is exposed from the opening.

### CROSS REFERENCE TO RELATED APPLICATION

This application claims priority to Japanese Patent Application No. 2018-201660 filed on Oct. 26, 2018, which is incorporated herein by reference in its entirety including the specification, claims, drawings, and abstract.

### TECHNICAL FIELD

The present disclosure relates to a vehicle front structure, and more particularly to a front structure of a vehicle including a lidar that emits laser light.

### BACKGROUND

A device called lidar (LIDAR) that detects obstacles ahead of a vehicle is known. A lidar emits laser light forward of a vehicle and detects laser light reflected at an obstacle to thereby detect the obstacle ahead of the vehicle. JP 2018-115925 A, for example, discloses a vehicle including a lidar.

A lidar, which emits laser light ahead of a vehicle, is therefore necessarily disposed in a front portion of a vehicle and may be secured to a body or a frame in a front portion of the vehicle.

A situation where a vehicle front portion collides with a pedestrian, particularly when a leg of a pedestrian comes into contact with a lidar directly or indirectly (that is, via another member) in collision, will be considered. If the pedestrian's leg comes into contact with the lidar which is secured to a body or a frame in the vehicle front portion, strong forward reaction force would be applied from the body or frame to the lidar. This hinders pedestrian leg protection performance of the vehicle.

An embodiment of the disclosure is directed toward inhibiting impairment of the pedestrian leg protection performance of a vehicle including a lidar in a front portion of the vehicle.

### SUMMARY

In accordance with an embodiment, a vehicle front structure includes a radiator grille having an opening, and a lidar configured to emit laser light and to be mounted on the radiator grille to allow the laser light to be emitted ahead of a vehicle through the opening.

In the above structure, the lidar is attached to the radiator grille. To secure a passage of air entering through the radiator grille, a space is typically formed behind the radiator grille. This structure allows the radiator grille to move rearward when the vehicle front portion collides with a pedestrian to bring a pedestrian's leg into direct or indirect contact with the lidar. This rearward movement of the radiator grille reduces forward reaction force applied to the lidar. Specifically, force input from the lidar to the pedestrian's leg is reduced to thereby inhibit impairment of the pedestrian leg protection performance of the vehicle. The above structure thus inhibits impairment of the pedestrian leg protection performance of a vehicle including the lidar in the vehicle front portion.

The radiator grille may include a planar mounting portion around a peripheral edge of the opening, and the lidar may be mounted on the mounting portion.

The radiator grille may include a mounting portion to which a lidar is attached.

The above vehicle front structure may further include a cover covering a joined portion where the mounting portion and the lidar are joined from forward of a vehicle.

The joined portion joining the mounting portion and the lidar, which is exposed and visible from the front of a vehicle, may spoil the appearance of a vehicle. The cover can make the joined portion invisible, thereby inhibiting deterioration of the appearance of the vehicle.

The cover may include a clip protruding from a rear face of the cover, and the cover may be detachably attached to the radiator grille by inserting the clip into a cover attaching hole in the mounting portion.

Adjustment of orientation of the lidar may be needed to adjust the emitting direction of laser light. In this case, the orientation of the lidar needs to be adjusted with the lidar being mounted on a vehicle, and therefore the cover attached to the radiator grille may hinder adjustment of the orientation of the lidar. However, as the cover is detachable, the orientation of the lidar can be adjusted as appropriate after removing the cover.

The vehicle front structure disclosed in the specification inhibits impairment of pedestrian leg protection performance of a vehicle including a lidar in the front portion of the vehicle.

### BRIEF DESCRIPTION OF DRAWINGS

An embodiment of the present disclosure will be described based on the following figures, wherein:

FIG. 1 is a rear view of a radiator grille according to the present embodiment;

FIG. 2A is a front view of a lidar assembly;

FIG. 2B is a rear view of the lidar assembly;

FIG. 3 is a rear view of the radiator grille to which the lidar assembly is attached;

FIG. 4 is a front view of the radiator grille to which the lidar assembly is attached;

FIG. 5 is an end view seen from A-A direction in FIG. 4;

FIG. 6A is a front view of a cover;

FIG. 6B is a rear view of the cover;

FIG. 6C is an enlarged side view of a clip of the cover; and

FIG. 7 is a front view of the radiator grille to which a pair of covers is attached.

### DESCRIPTION OF EMBODIMENTS

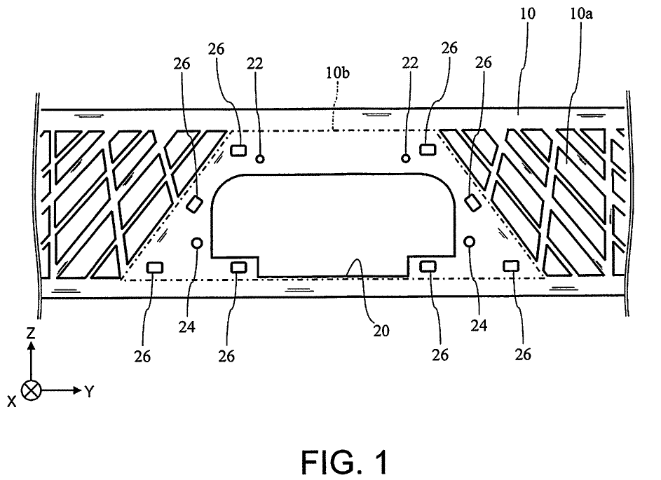

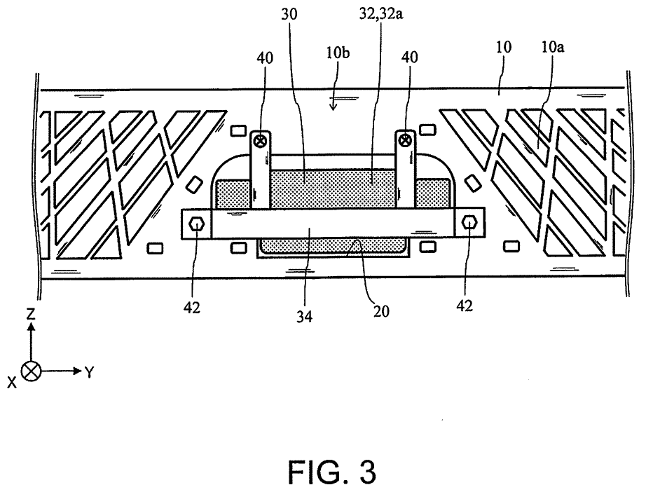

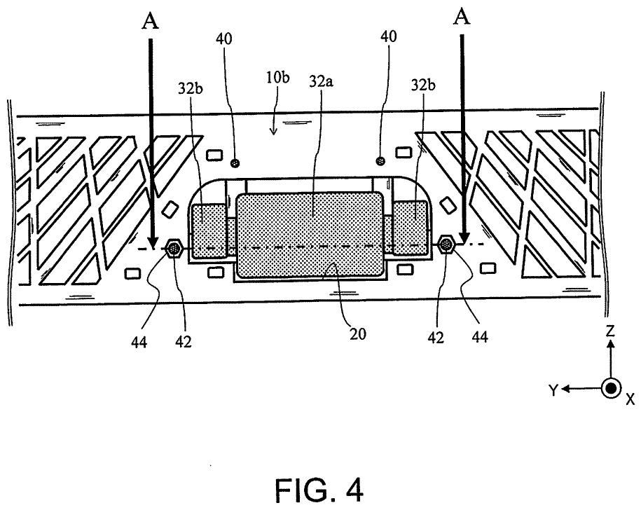

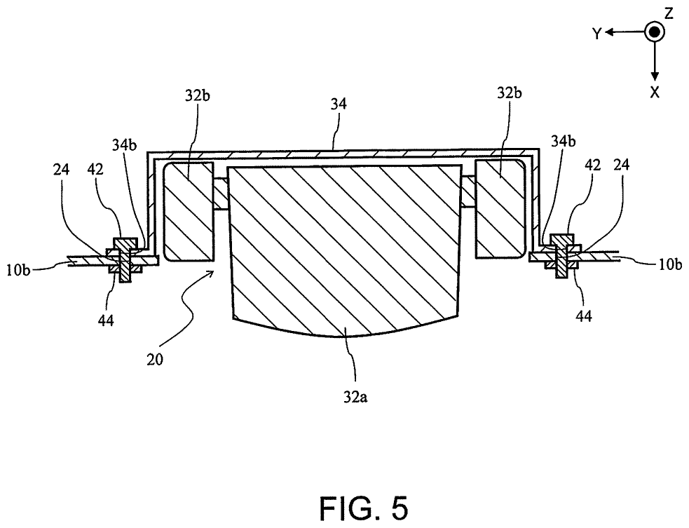

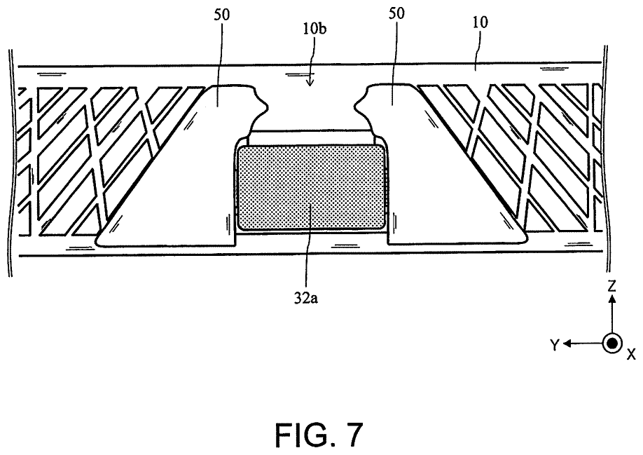

A vehicle front structure according to the present embodiment will be described. FIG. 1 is a rear view of a radiator grille (front grille) 10 according to the present embodiment. In FIG. 1 (and also in FIG. 3, FIG. 4, FIG. 5, and FIG. 7), an X axis denotes the longitudinal direction of a vehicle (forward direction of the X axis corresponds to the frontward direction), a Y axis denotes the vehicle width direction (forward direction of the Y axis corresponds to the rightward direction), and a Z axis denotes the vehicle height direction (forward direction of the Z axis corresponds to the upward direction). In the specification, the vehicle longitudinal direction is simply referred to as frontward or rearward, the width direction when the vehicle faces frontward is simply referred to as leftward or rightward, and the vehicle height direction is simply referred to as upward or downward.

The radiator grille 10 is a planar member disposed in a front portion of a vehicle and extending along the vehicle width. The radiator grille 10 is made of resin. In the present embodiment, the radiator grille 10 is made of ABS resin. The radiator grille 10 has rigidity that is lower than that of at least a body or a frame of a vehicle.

The radiator grille 10 includes a grating portion having a plurality of air holes 10a. Air enters through the air holes 10a into an engine or a radiator to cool the engine or the radiator. To secure passage of the air from the air holes 10a into the interior of the vehicle, a space is formed behind the radiator grille 10.

The radiator grille 10 includes a planar mounting portion 10b. As will be detailed below, the mounting portion 10b is configured to receive a lidar. In the present embodiment, the mounting portion 10b is disposed in the center of the radiator grille 10 in the vehicle width direction, and has a substantially trapezoidal outer shape. The mounting portion 10b is integrally molded with the grating portion having the air holes 10a, and is also made of resin (ABS resin in the present embodiment).

The mounting portion 10b includes an opening 20 in the center portion. In other words, the mounting portion 10b is formed around the peripheral edge of the opening 20. Laser light emitted by the lidar passes through the opening 20.

The mounting portion 10b further includes a plurality of screw holes 22 and a plurality of bolt holes 24. These screw holes 22 and the bolt holes 24 are used to mount the lidar onto the mounting portion 10b.

The mounting portion 10b further includes a plurality of cover attaching holes 26. The cover attaching holes 26 are used to attach the cover, which will be described below, to the mounting portion 10b.

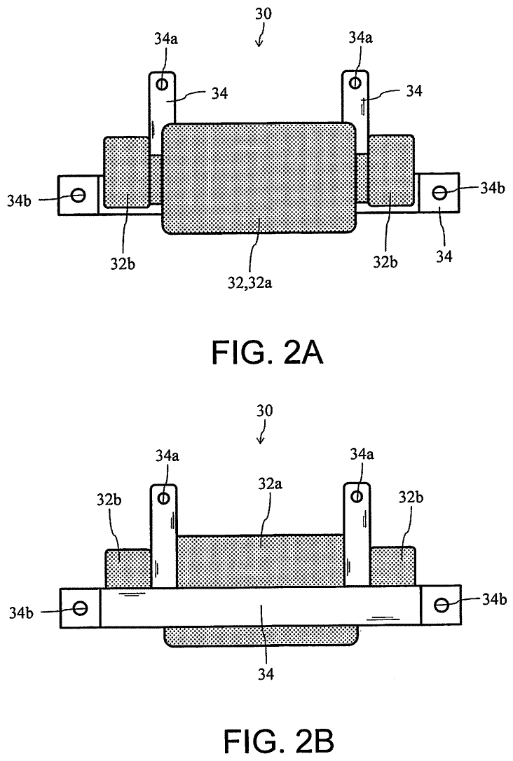

FIG. 2A is a front view of a lidar assembly 30 according to the present embodiment, and FIG. 2B is a rear view of the lidar assembly 30. The lidar assembly 30 includes a lidar 32 and an attachment 34.

The lidar 32 includes a lidar body 32a and an adjustment mechanism 32b.

The lidar body 32a includes an emitting unit for emitting pulsed laser light forward of the vehicle, a light receiving unit for receiving reflected light from an obstacle, and a transmitting unit for transmitting received light information representing strength of the reflected light received by the light receiving unit to an ECU (not shown) of the vehicle. The ECU is capable of detecting an obstacle ahead of the vehicle based on the received light information, and is also capable of measuring the distance to the obstacle based on a time period from the time when laser light is emitted to the time when the reflected light is received.

The adjustment mechanism 32b supports the lidar body 32a such that the orientation of the lidar body 32a (particularly the emitting unit and the light receiving unit) is adjustable. The orientation of the lidar body 32a is adjusted by an operator.

The attachment 34 is an attaching member designed for attaching the lidar 32 to the radiator grille 10, and is fixed to a rear face of the lidar 32. In the present embodiment, the attachment 34 is composed of a horizontal member extending laterally (along the vehicle width in the attached position) and two vertical members extending vertically (along the vehicle height in the attached position) from the horizontal member. The two vertical members each include, at their distal ends, the screw hole 34a, and the horizontal member includes, at its laterally opposite ends, the bolt holes 34b.

FIG. 3 is a rear view of the radiator grille 10 to which the lidar assembly 30 is attached, FIG. 4 is a front view of the radiator grille 10 to which the lidar assembly 30 is attached, and FIG. 5 is an end view viewed from A-A direction in FIG. 4.

The front surface of the attachment 34 is brought into contact with the rear surface of the mounting portion 10b such that the screw holes 34a of the attachment 34 and the screw holes 22 of the radiator grille 10 are aligned, and the bolt holes 34b of the attachment 34 and the bolt holes 24 of the mounting portion 10b are aligned. In this state, screws 40 are inserted into the respective screw holes 34a and fixed to the screw holes 22 from the rear surface. Also, the bolts 42 are inserted, from the rear surface, into the bolt holes 34b and the bolt holes 24, and fastened with nuts 44 on the front surface of the mounting portion 10b. Thus, the lidar assembly 30 (LIDAR 32) is mounted on the mounting portion 10b.

As illustrated in FIG. 5, in the mounted state, the lidar body 32a is exposed from the opening 20. This structure allows the lidar body 32a to emit laser light forward via the opening 20 and to receive reflected light from the obstacle via the opening 20.

In the present embodiment, the adjustment mechanism 32b of the lidar 32 is also exposed forward from the opening 20. This facilitates adjustment of the orientation of the lidar body 32a by an operator.

As described above, the lidar 32 of the present embodiment is attached to the radiator grille 10. The radiator grille 10 is a planar member made of resin and has relatively lower rigidity (at least lower than that of the body or frame), and a space is formed behind the radiator grille 10, as described above. Therefore, when the vehicle front portion collides with a pedestrian and a pedestrian's leg is brought into direct or indirect contact with the lidar 32, the radiator grille 10 deforms or moves backward to reduce the forward reaction force applied to the lidar 32. The forward reaction force is smaller at least compared to the structure in which the lidar 32 is fixed to the body or frame. In other words, the force applied from the lidar 32 to the pedestrian's leg is reduced to thereby inhibit impairment of pedestrian leg protection performance of the vehicle. Thus, the vehicle front structure of the present embodiment inhibits impairment of the pedestrian leg protection performance of a vehicle including the lidar 32 in the front portion of the vehicle.

In the above structure in which the lidar 32 is mounted on the radiator grille 10 (mounting portion 10b), joined portions where the mounting portion 10b and the lidar 32 are joined together may be visible from frontward of the vehicle. As illustrated in FIG. 4, the screws 40, the bolts 42, and the nuts 44 serving as the joined portions are visible from frontward of the vehicle. This impairs appearance of the vehicle. To avoid this problem, a cover covering the joined portions where the mounting portion 10b and the lidar 32 are joined together from frontward is attached to the radiator grille 10.

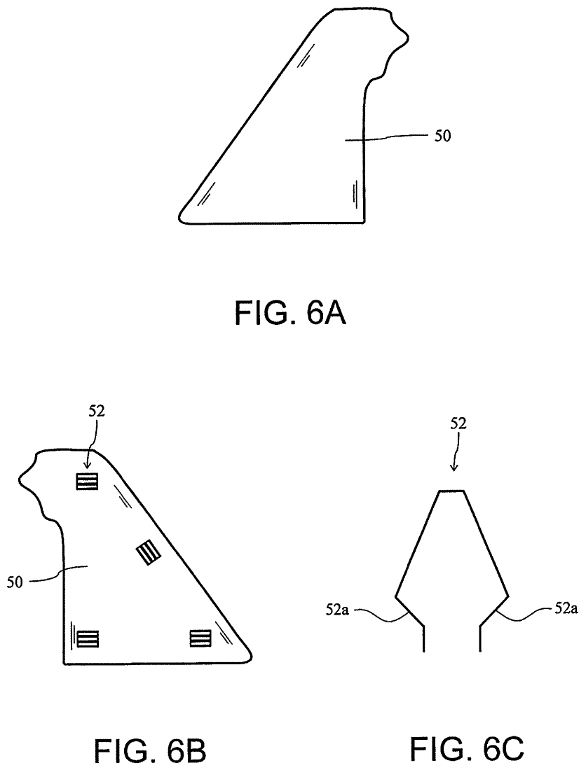

FIG. 6A is a front view of a cover 50 and FIG. 6B is a rear view of the cover 50. While FIG. 6A and FIG. 6B illustrate a single cover 50, in the present embodiment, two symmetrical covers 50 are attached to the radiator grille 10. The cover 50 has a shape corresponding to the shape of the mounting portion 10b so as to cover the substantial portion of the mounting portion 10b.

As illustrated in FIG. 6B, the cover 50 includes a plurality of clips 52 protruding from its rear face. Each clip 52 is inserted into a cover attaching hole 26 in the mounting portion 10b from the front face of the mounting portion 10b, thereby attaching the cover 50 to the mounting portion 10b. FIG. 6C is a side view of the clip 52. As illustrated in FIG. 6C, the clip 52 includes projections 52a. When the clip 52 is inserted into the cover attaching hole 26, the projection 52a engage with the rear face of the mounting portion 10b, thereby attaching the cover 50 to the mounting portion 10b.

Pulling the cover 50 strongly forward disengages the projection 52a from the mounting portion 10b, allowing the cover 50 to be removed. In this manner, the cover 50 is detachably attached to the mounting portion 10b by means of the clips 52 and the cover attaching holes 26.

FIG. 7 is a front view of the radiator grille 10 with a pair of covers 50 attached to the mounting portion 10b. As illustrated in FIG. 7, the cover 50 covers the joined portions where the mounting portion 10b and the lidar 32 are joined together to make the joined portions invisible, inhibiting deterioration of the appearance of the vehicle. In order to further improve the appearance, the front face of the cover 50 may be decorated.

In the present embodiment, the cover 50 has a shape corresponding to the shape of the mounting portion 10b, and therefore covers the substantial portion of the mounting portion 10b from the front. This structure makes the mounting portion 10b invisible from frontward of the vehicle, which inhibits deterioration of the appearance of the vehicle.

As illustrated in FIG. 4, the adjustment mechanism 32b of the lidar 32 is exposed from the opening 20. In the present embodiment, the cover 50 also covers the adjustment mechanism 32b exposed from the opening 20 from frontward. This structure also makes the adjustment mechanism 32b invisible from frontward of the vehicle, which further inhibits deterioration of the appearance of the vehicle. As the lidar body 32a emits laser light frontward of the vehicle, it is natural that the front of the lidar body 32a should not be covered with the cover 50.

It is necessary to adjust the orientation of the lidar body 32a with the lidar 32 mounted on a vehicle. While the cover 50 makes adjustment of the orientation of the lidar body 32a difficult, the cover 50 of the present embodiment, which is detachable, can be removed to allow an operator to adjust the orientation of the lidar body 32a as appropriate.

While an embodiment of the disclosure has been described, the disclosure is not limited to the above embodiment and may be modified in various manners without departing from the gist of the disclosure.

1. A vehicle front structure comprising:
a radiator grille having an opening; and
a lidar configured to emit laser light, the lidar being configured to be mounted on the radiator grille to allow the laser light to be emitted ahead of a vehicle through the opening.

2. The vehicle front structure according to claim 1, wherein
the radiator grille includes a planar mounting portion around a peripheral edge of the opening, and
the lidar is mounted on the mounting portion,

3. The vehicle front structure according to claim 2, further comprising:
a cover covering a joined portion where the mounting portion and the lidar are joined from forward of a vehicle.

4. The vehicle front structure according to claim 3, wherein
the cover includes a clip protruding from a rear face of the cover, and
the cover is detachably attached to the radiator grille by inserting the clip into a cover attaching hole in the mounting portion.
